(19) United States
(12) Patent Application Publication
(10) Pub. No.: US 2017/0059537 A1
(43) Pub. Date: Mar. 2, 2017

(54) Method for Analyzing Mixture Components

(71) Applicant: Huajun Zhang, Suzhou (CN)

(72) Inventors: Huajun Zhang, Suzhou (CN); Ning Ying, Suzhou (CN)

(21) Appl. No.: 15/120,974

(22) PCT Filed: Feb. 12, 2015
(86) PCT No.: PCT/CN2015/072818

§ 371 Date: Aug. 23, 2016

(30) Foreign Application Priority Data
Mar. 25, 2014 (CN) 201410113885.6

(51) Int. Cl. G01N 30/86

(52) U.S. Cl. CPC G01N 30/8679; G01N 30/8631

(57) ABSTRACT

The present invention relates to a method for analyzing mixture components, comprising: (1) separating a mixture sample by using chromatographic technology, to obtain a preliminary chromatogram; (2) sampling as required any one interval in the preliminary chromatogram obtained in step (1), to obtain a series of spectrograms in different retention times, which are referred to as compound spectrograms; (3) performing calculation, by using a series of methods of an entropy minimum algorithm, in the mixture spectrograms obtained in step (2), to obtain each reconstructed pure spectrum and a corresponding pseudo concentration thereof. The method combines the chromatographic technology and the entropy minimum algorithm, and overcomes dependence on component separation in an existing analysis method, making separation not important any more. There is no need to completely separate each component in the mixture. Meanwhile, a prerequisite for using the entropy minimum algorithm is met. The method is universal, fast, and highly efficient, requires low costs, does not have high requirements on personnel, and has a great application prospect.

### TECHNICAL FIELD

The present invention relates to the field of chemical analysis, and more particularly, to a method for analyzing mixture components.

### BACKGROUND ART

Among existing analytical methods, various types of chromatographic analytical methods are mostly employed to analyze components of a mixture, i.e., different physical and chemical properties of components of a mixture in stationary and mobile phase in various chromatographies will result in discrepancy in moving speeds of the components in the chromatography, such that the components pass through various detectors (such as ultraviolet, infrared and mass spectrometric) at different times to obtain various chromatograms, thereby separating and differentiating the components in the mixture.

### Analyses of Full Components of Mixture:

The typical analytical methods to analyse components of a complex mixture, are to repeatedly carry out a chromatographic analysis under different conditions (for instance, changing a temperature, changing a temperature gradient profile, changing a flow rate, using a different stationary phase (by changing the chromatographic column) and a different mobile phase) to separate out a part of components each time. Results obtained under various conditions are consolidated to obtain a more complete analysis result. However, even after many trials, it is not conclusive if the conventional methods have been successful in the separation of all of the components.

Existing analytical methods to completely separate all components of a complex mixture is a very time-consuming, labour-intensive and costly process; it also cannot be universally applied to other samples. Normally, analysis of a complex mixture such as garlic extraction requires not only years of R&D but also several or dozens of millions of funds and many qualified professionals. Moreover, as different mixtures are comprised of different matrix, existing analytical methods cannot be universally applied. For example, an analytical method developed for the garlic extraction cannot be directly applied to analysis of onion extraction which necessitates a further input of large amount of investments, time and manpower in method development to obtain accurate results.

The greatest difficulty for existing analytical methods in complete analysis of complex mixtures is: separation, that is, how to make individual component of a mixture to be well separated. This is especially the case for more complex mixtures, where the complete separation of a mixture after only a few times is impossible. Thus, the overlapping of bands in the spectra (mixture spectra) cannot be avoided and is especially so for traditional medicines or natural products which are mixtures of thousands of components. How to separate all the components of a mixture rapidly before analysis is a challenge to the world.

### Analysis of Target Compounds:

The analysis of target compounds such as the analysis of food, medicine and environment samples for safety concerns requires either the target compound to be purified or the target compound in the sample to be subjected to physicochemical treatments like deuteration. These pretreatments are usually complicated and time-consuming. The treated samples have to be subjected to chromatographic separation by separating the target compound out from the background matrix so as to obtain qualitative and quantitative information.

As different target compounds often require drastically different analytical instruments and conditions for their detection and analysis, a typical analysis centre is normally only specialized for the detection and analysis of specific target compounds with corresponding relatively higher costs spent in analysis.

Like the analysis of the full components of a mixture, the core problem in the analysis of target compounds is separation. Hence, by solving the problem of separation, we can simultaneously solve the core problem in the analysis of the components of a mixture.

### Entropy Minimization Algorithms:

Mathematical methods are widely utilised in analytical instruments and analytical methods to solve the numerous problems encountered during analysis such as the problem of baseline. Such mathematical methods are collectively called Chemometrics.

One type of chemometrics (such as SIMPLSMA, IPCA, OPA-ALS) is mainly utilised for the extraction of the pure component spectra from a mixture spectra dataset. However, these methods require certain prerequisites and information, such as the peaks of every pure components inside the overlapping spectra must be symmetrical (such as Gaussian symmetry), the peak to peak distance of the spectra bands must be of a certain length, the degree of overlapping cannot be too high and furthermore, an accurate guess of the components in the mixture is required. Due to the numerous prerequisites, these mathematical methods are very limited in the deconvolution of the pure component spectrum from the mixed spectra and can only function as auxiliary methods. This is especially the case for complex mistures, such as the traditional medicine or natural product samples, whereby information about constituent components cannot be guessed and the overlapping spectra obtained during the analysis cannot reach the requirements of these methods.

Entropy Minimization (EM) algorithms are developed from Shannon Entropy. The individual pure component spectra can be reconstructed using only the mixture spectra dataset without prior information. The principle of Shannon Entropy is first published in the year 1948. [C. E. Shannon, The Bell System Technical Journal, 27 (1948) 379-423.] It is an academic term in the field of information technology whereby it is used to evaluate the uncertainty of a random variable.

The first person to apply Shannon Entropy for chemical analysis is Marc Garland [Y. Z. Zeng, M. Garland, Analytica Chimica Acta, 359 (1998) 303-310.], who further published in 2002 an article on BTEM (Band-Target Entropy Minimization) [W. Chew, E. Widjaja, M. Garland, Organometallics, 21 (2002) 1982-1990.]. This algorithm is utilized for separation of simple infrared mixture spectra dataset. BTEM requires supervised operation for its application which is used mainly within the research domain.

Zhang Huajun et al. in 2003 published tBTEM algorithm (Weighted Two-Band Target Entropy Minimization) [H. J. Zhang, M. Garland, Y. Z. Zeng, P. Wu, J Am Soc Mass Spectrum, 14 (2003) 1295-1305.]. This algorithm has been primarily applied to mass spectra at the beginning, and meanwhile the algorithm which performs an automatic analysis and remove overlapped spectra was published as well.

Zhang Huajun et al. in 2006 published MREM algorithm (Multi-Reconstruction Entropy Minimization) [H. J. Zhang, W. Chew, M. Garland, Applied Spectroscopy, 61 (2007) 1366-1372.]. The algorithm uses local optimization method instead of global optimization method, thus neglecting the need for a manual input to preset the search parameters, achieving an unsupervised automatic exhaustive search feature that can search for pure spectra automatically.

In 2009, EM algorithms were successfully applied to the reconstruction of individual UV-Vis spectra [F. Gao, H. J. Zhang, L. F. Guo, M. Garland, Chemometrics and Intelligent Laboratory Systems, 95 (2009) 94-100.]. Since UV spectra are very broad, peaks are asymmetrical in shape and the overlapping of spectra of components is extremely serious, it is extremely difficult to resolve individual UV-Vis spectra from mixtures of 2 or 3 components.

The EM algorithms (BTEM, tBTEM and MREM etc.) can be applied, by just using the mixture spectra dataset, to reconstruct the pure component spectra from multi-component mixture spectra without the use of prior information. They have been successfully applied to infrared (IR), ultraviolet (UV), mass spectrometry (MS) and nuclear magnetic resonance (NMR) spectra.

Prerequisites for the application of EM algorithms are: 1) The number of mixture spectra should be greater than the number of observable components in the mixture; for example, if a mixture contains 10 observable components, the number of mixture spectra obtained by computer sampling should be greater than 10; 2) each component should have a different concentration ratio in each of the different mixture spectra; if the proportion of any two or more components in the mixture spectra at different sampling times are consistent, these components cannot be resolved by using EM algorithm. According to the present literature, the utilisation of the different EM algorithms relies on the detector to detect the concentration changes during the progress of a dynamic reaction. At different reaction time, sampling is carried out to obtain a lot of different mixture spectra whereby the proportion of each of its components is not constant. For example, during a chemical reaction carried out under non-equilibrium conditions, a total of 20 mixture spectra can be obtained from 20 different sampling times. As the reaction progress passes with time, the concentration of the reactants and products changes over time, resulting in that the concentration ratio of reactants and products at each different sampling point is not constant.

However, for the chemical analysis of a real mixture sample, such as a medicine sample or milk sample, the concentration ratio of each component in the sample is constant, hence it can not meet the above two conditions required by the EM algorithms. Thus, a main challenge is to devise a method to obtain many mixture spectra with different proportions of its components from a sample that has a constant concentration ratio so as to take advantage of EM methods for analysis.

### SUMMARY OF THE INVENTION

To solve the technical problems mentioned above, the object of the present invention is to provide a method for analysing components of mixtures. This method will combine both the strengths of both chromatography techniques and EM algorithms so as to quickly analyze components of a mixture.

The present invention provides a method for analyzing mixture components, comprising the steps of:

(1) separating mixture samples using chromatographic techniques to obtain preliminary chromatograms;
(2) within any range of the preliminary chromatograms as obtained from step (1), carrying out a sampling as required, so as to obtain a series of spectra at different retention time, which is called the mixture spectra (i.e., a mixed spectra);
(3) using serial methods of the EM algorithms (namely, serial EM methods) on the mixture spectra obtained from step (2) to calculate various reconstructed pure spectra and the corresponding pseudo concentrations.

Wherein, the preliminary chromatogram obtained from step (1), include peaks of pure component (already separated component) and the overlapping peaks of the mixture.

Furthermore, peaks of pure component can be analyzed and identified using conventional methods and normally do not require further analysis and processing by means of the subsequent steps of the method according to the present invention, though the user can do so if desired.

However, for the overlapping peaks of the mixture, it is required to analyze them using the subsequent steps (step (2) and step (3)) of the method according to the present invention as outlined above.

Wherein, any range of the preliminary chromatograms obtained in step (1) refers to a part of the preliminary chromatogram, or the whole preliminary chromatogram. Further, the data sampling mentioned in step (2) refers to exporting the data of the desired range from within the data generated by the instrument. However, the uniformity of the sampling is affected by the instrument itself.

In step (1), the chromatographic techniques are: gas chromatography (GC), liquid chromatography, or a combination of both.

In step (1), mixture spectra can be obtained by a detector after using chromatographic techniques to carry out separation.

Further, the detector can be selected from the group comprising one or a combination of MS, IR, UV, fluorescence, spectrophotometer and NMR detectors.

In step (3), serial EM methods is a collective term comprising a variety of methods based on Shannon Entropy, including, but not limited to, BTEM (Band-Target Entropy minimization), tBTEM (Weighted Two-Band Target Entropy Minimization) or MREM (Multi-Reconstruction Entropy Minimization) algorithms individually or in combination.

Further, for each operation of the BTEM or tBTEM method, the user can obtain one reconstructed pure spectrum; for each operation of the MREM method, the user can obtain multiple reconstructed pure spectra.

The “reconstructed pure spectrum” of the present invention means: the use of various EM algorithms to calculate a pure spectrum from the mixture spectra.

For the present invention, the “various reconstructed pure spectra and the corresponding pseudo concentration” means when using EM algorithms to reconstruct the pure spectra, we can at the same time calculate out the concentrations of the pure components that correspond to the reconstructed pure spectra (also called “pseudo-concentration”).

For step (3), for the analysis of a mixture sample containing an unknown substance, one need to obtain as much information as possible on the components from the mixture spectra obtained in step (2) before one experiment with different parameters to carry out repeated calculation using the EM algorithms so as to get as many reconstructed pure spectra as possible.

Wherein, different parameters refer to targeting different peaks, using different objective functions and penalty functions or using different optimization methods. For example: in mixture spectra with m/z ranging from 100-200 (with an interval of 1 m/z), the data has a total of 101 m/z channels; each channel can be targeted to do calculation, or any two channels can be arbitrarily selected for calculation; or only the channels whose value is greater than 30% of the channel value of the highest peak are targeted for calculation.

Multiple calculations refers to calculations using different parameter settings so as to obtain a reconstructed pure spectrum (BTEM or tBTEM algorithm) or a plurality of reconstructed pure spectra (MREM algorithm) in each calculation. Multiple calculations have to be carried out with the many different parameter settings.

As many reconstructed pure spectra as possible means after several calculations, there will be multiple duplicate estimates of the real spectrum. The algorithm can remove any duplicate spectrum, so that all of the remaining pure spectra are unique.

Wherein, in step (3), to analyse if a mixture sample has a target compound/known compound, the target compound/known compound standard spectrum can be used as a reference for calculation using EM algorithms. Reconstruction using different parameters can be used to obtain the target compound/known compound's reconstructed pure spectrum. During multiple reconstruction, if the reconstructed pure spectrum and the standard spectrum of the target compound/known compound are compared and found to be consistent, and the pseudo-concentration of the reconstructed pure spectrum is meaningful, it can be concluded that the mixture contains the target compound/known compound; otherwise, the target compound/known compound is absent.

Furthermore, multiple reconstruction (e.g., based on the pure spectrum of the target compound) refers to the process of targetting every data channel whose intensity is greater than 30% of the intensity of the highest peak or simply targetting every channel and then do calculation.

To decide if the pseudo-concentration of the reconstructed pure spectrum is meaningful, and empirical. In a typical chromatographic column analysis, the peak shape obtained generally is a relatively symmetrical peak, rather than those obtained due to random values.

After finishing step (3) of the present invention, the reconstructed pure spectra can be compared with the standard spectra found in a standard database to confirm their information; if the reconstructed pure spectrum is consistent with one of the standard spectrum in the standard database, the reconstructed pure spectrum can be confirmed to be the component as represented in the spectrum of the standard database. If after comparison, the reconstructed pure spectrum and all standard spectra in that particular standard database are inconsistent, it indicates that a new chemical component that is included in the standard database has been found. Subsequently, the reconstructed pure spectrum can be compared with other databases or the components can be identified by using a variety of analytical methods if necessary.

The method of the present invention has the following advantageous effects:

1) This invention mainly overcomes the reliance of the existing analytical methods on component separation, and overcomes the technical bottlenecks of the existing analytical methods by making separation no longer a crucial step;
2) This invention combines both chromatographic techniques and EM algorithms together to overcome the shortcomings thereof;
3) By using the combination of chromatographic techniques and EM algorithms, it is no longer necessary to completely separate the various components of a mixture, and meanwhile this also meets a prerequisite required by the EM algorithms;
4) This invention expands the application scope of EM algorithm so as to analyse mixture samples that have a constant concentration ratio among its various components;
5) This invention enables the analysis of both an unknown component in a mixture sample and a mixture with a target compound/known compound, and thus obtains both qualitative and quantitative analyses of all the components;
6) The Method in this invention is a universal analytical method that is applicable to all of the different types of mixture samples;
7) By applying this invention, a fast process is achieved as there is no need to spend significant time on separation; and the cost is low as there is no need to buy high quality separation equipments and and also the manpower requirements are not high.

In summary, the present invention provides a method for analyzing the mixture components by combining chromatographic techniques with EM algorithm so as to overcome the reliance of the existing analytical methods on component separation, which renders separation no longer a crucial step; it is no longer necessary to completely separate the various components of a mixture, and meanwhile this also meets a prerequisite required by the EM algorithms; this method is universal, fast, highly efficient, and cost-effective with low manpower requirements and has a promising prospect for many analytical applications.

### BRIEF DESCRIPTION OF THE DRAWINGS

FIG. 1 is an analytical flowchart of the application of EM algorithms on mixture samples (all are unknown samples).

FIG. 2 is an analytical flowchart of the application of EM algorithms on mixture samples containing target compounds/known compounds.

FIG. 3 is a TIC spectrum of a jet fuel sample with peak time of 14 to 15 minutes as described in Example 1.

FIG. 4 is a 3-D mixture mass spectrum, which shows the data obtained by exporting a total of 176 times from the TIC spectrum of a jet fuel sample which has a peak time of 14 to 15 minutes as described in Example 1.

FIG. 5-1 is an EI-MS pure spectrum of the linear alkane n-undecane (obtained from Japan AIST database) as described in Example 1.

FIG. 5-2 is the EI-MS pure spectrum of the linear alkane n-dodecane (obtained from Japan AIST database) as described in Example 1.

FIG. 6-1 is a pure spectrum obtained through calculation using EM algorithms by targeting peak m/z=57 and 170 as described in Example 1.

FIG. 6-2 is the pseudo-concentration corresponding to the pure spectrum obtained through calculation using EM algorithms by targeting peak m/z=57 and 170 as described in Example 1.

FIG. 7-1 is a pure spectrum obtained through calculation using EM algorithms by targeting peak m/z=128 as described in Example 1.

FIG. 7-2 is the pseudo-concentration corresponding to the pure spectrum obtained through calculation using EM algorithms by targeting peak m/z=128 as described in Example 1.

FIG. 8 is a TIC spectrum of a volatile sample, with m/z ranging from 800 to 850 second as described in Example 2.

FIG. 9 is a 3-D mass spectrum of a volatile sample, with TIC ranging from 826.22 to 831.707 second as described in Example 2.

FIG. 10-1 is a reconstructed pure spectrum obtained through calculation using EM algorithms by targeting peak m/z=91 as described in Example 2.

FIG. 10-2 is the pseudo-concentration corresponding to the reconstructed pure spectrum obtained through calculation using EM algorithms by targeting peak m/z=91 as described in Example 2.

FIG. 11 is a comparison of a reconstructed pure spectrum obtained by targeting peak m/z=91 with the standard spectra obtained from NIST database as described in Example 2; wherein the upright peaks correspond to the reconstructed pure spectrum, and the inverted peaks correspond to NIST standard spectra.

FIG. 12-1 is a reconstructed pure spectrum obtained through calculation using EM algorithms by targeting peak m/z=71 as described in Example 2.

FIG. 12-2 is the pseudo-concentration corresponding to the reconstructed pure spectrum obtained through calculations using EM algorithms by targeting peak m/z=71 as described in Example 2.

FIG. 13 is a comparison of a reconstructed pure spectrum obtained by targeting peak m/z=71 with the standard spectra obtained from NIST database as described in Example 2; wherein the upright peaks correspond to the reconstructed pure spectrum, and the inverted peaks correspond to NIST standard spectra.

FIG. 14-1 is a reconstructed pure spectrum obtained through calculations using EM algorithms by targeting peak m/z=105 as described in Example 2.

FIG. 14-2 is the pseudo-concentration corresponding to the reconstructed pure spectrum obtained through calculations using EM algorithms by targeting peak m/z=105 as described in Example 2.

FIG. 15 is a comparison of a reconstructed pure spectrum obtained by targeting peak m/z=105 with the standard spectra obtained from NIST database as described in Example 2; wherein the upright peaks correspond to the reconstructed pure spectrum, and the inverted peaks correspond to NIST standard spectra.

FIG. 16-1 is a reconstructed pure spectrum obtained through calculations using EM algorithms by targeting peaks m/z=57 and 85 as described in Example 2.

FIG. 16-2 is the pseudo-concentration corresponding to the reconstructed pure spectrum obtained through calculations using EM algorithms by targeting peaks m/z=57 and 85 as described in Example 2.

FIG. 17 is a comparison of a reconstructed pure spectrum obtained by targeting peaks m/z=57 and 85 with the standard spectra obtained from NIST database as described in Example 2; wherein the upright peaks correspond to the reconstructed pure spectrum, and the inverted peaks correspond to NIST standard spectra.

FIG. 18 is a view illustrating a comparison of the concentration of the 4 reconstructed pure spectra, the total reconstructed TIC concentration and the real TIC concentration as described in Example 2.

FIG. 19 is an illustration of value space and optimization method: in one optimization, BTEM/tBTEM algorithm can only find a pure spectrum corresponding to the global minimum; while MREM algorithm can find many pure spectra corresponding to many local minima.

### DETAILED DESCRIPTION OF THE PREFERRED EMBODIMENTS

The following examples are used to illustrate the invention but are not intended to limit the scope of the invention.

The materials used in this invention are commercially available normal materials. Other operating procedures that are not mentioned in this invention are conventional operations in the art.

Take a gas chromatography—mass spectrometry method (GC-MS) as an example (the flowchart of which is shown in FIG. 1, analyzing a mixture sample containing an unknown compound): One mixture sample comprising a mixture of A, B, C . . . and Z components was injected into a GC instrument. As different components have different physiochemical properties (polarity, molecular size etc.), the movement of different components through the column are at different rate, thus leading to the time for each component to reach the detector (mass spectrometer) to be different, which results in the appearance of different peaks. In FIG. 1, peaks 1, 2 and 3 are peaks of pure components (already separated components), while peak 4 is an overlapping peak of a mixture whose components have not yet been separated. For the existing analytical methods, a component has to be separated from other components before identification (such as peaks 1, 2 and 3). For components that have not been separated (such as the overlapping peak 4), the existing conventional procedure is to inject the same sample under different conditions to undergo different separation. Separation of the mixture to all its components is only successful after repeated separation attempts carried out under different separation procedures. As different samples have different components, the analytical method cannot be universally applied. For existing analytical methods, most of the time and effort are spent on optimising the separation procedures. These often require complex sample preparation process to reduce the number of components in a sample so as to reduce the difficult in chromatographic separation.

In the present invention, the first step is to use GC to separate components in the mixture sample, and contents in sample then pass through the detector (MS) to produce a spectrum (i.e. a preliminary spectrum) of the mixture. For peaks of pure components (the peaks which components have been separated, such as peaks 1, 2 and 3), no further processing is required. For the overlapping mixture peak, such as the overlapping peak 4, the present invention is to utilize data exporting, i.e. data exporting is carried out at different sampling time (the exporting need not be uniform). This results in a series of mixed spectra (i.e. mixture spectra) which, upon being subjected to multiple operations of EM algorithms, lead to different reconstructed pure spectra and corresponding pseudo-concentrations.

Separate a sample with a fixed proportion in the concentrations of its components by means of chromatographic techniques. After chromatographic separation, a series of pure component or mixture spectra containing different components of different concentration ratios can be obtained at the detector side. For overlapping peaks of unseparated mixture components, by exporting multiple times (data exporting at different time) through computers, the number of mixture spectra obtained will be more than the number of components of a mixture as represented by the overlapping peaks. The moving speed of different compounds inside the column will always have difference regardless of the separation capability of a chromatographic column. Hence, at any retention time, the ratios between the components are not the same, thereby meeting the prerequisite for the application of the series of the EM algorithms.

In the present invention, separation of components in a mixture is mainly reliant on EM algorithms to reconstruct pure components' spectra, so the separation does not depend greatly on separation capability of a chromatographic column although good chromatographic separation is still a welcome, since it would reduce the number of overlapping peaks and therefore result in less mathematical processing by EM algorithms. Because components of different mixture samples vary greatly from each other, the same chromatographic separation method will lead to different separation results. This is the problem existing in the common separation techniques and the reason why the existing separation techniques are not universal for different samples. As the present invention relies only on deconvolution of the overlapping peaks of a mixture, different separation results from different mixture samples make no difference to the present invention; that is to say, the present invention can be utilised for different overlapping peaks of a mixture regardless of where these peaks appear. Therefore, the present invention provides a universal method for analysis, and is insensitive to the composition of the sample. At the same time, the present invention can significantly reduce the sample preparation process because samples that have not been pre-treated will have more overlapping peaks of a mixture after chromatographic separation, it does not affect the utility of the present invention and only increase the amount of calculation.

Using the present invention, a pure spectrum can be reconstructed from mixed spectra (mixture spectra). However, the present invention alone cannot identify what substances these pure spectra represent. This can easily be solved by, for example, gas chromatography-electron ionization mass spectrometry method (GC-EI-MS). Thus, by comparing the pure spectrum with the huge amount of component standard spectra in EI-MS database (e.g. NIST MS database) or other component database, we can easily identify the substances represented by pure spectra.

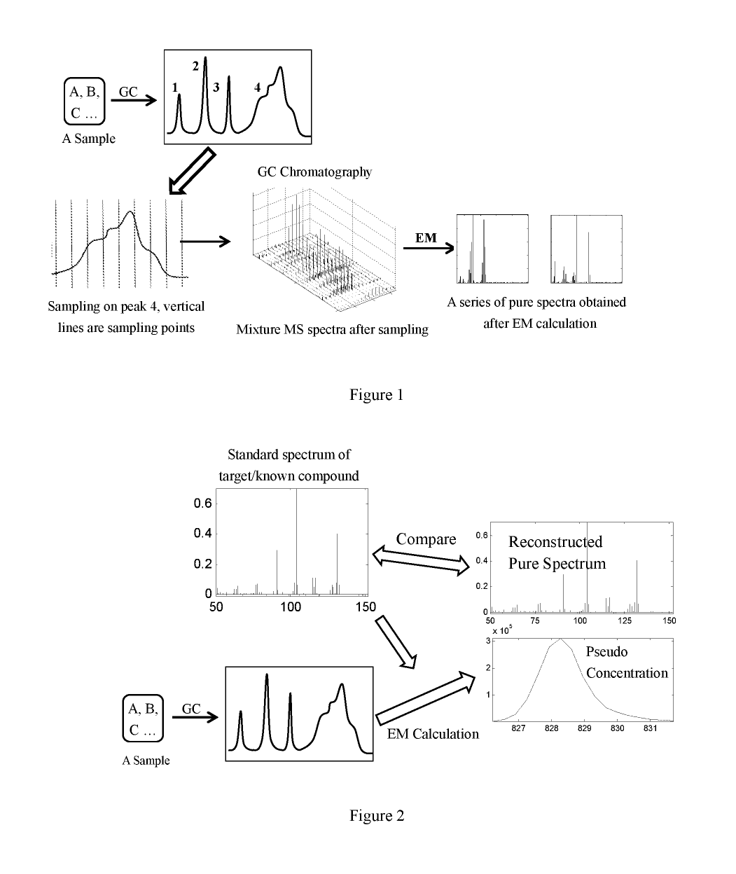

The present invention is a very useful method for the analysis of the target/known compound in a mixture sample (namely, the analysis of the mixture sample containing the target/known compound). By using only the standard spectrum of target/known compound and designing application procedures in the EM algorithms (e.g. by targeting the target/known compound characteristic peaks or characteristic spectrum range, etc.), we can calculate from any poorly separated spectra whether it contains the target compound/known compound and its corresponding pseudo-concentrations. Among multiple reconstructed procedures, if any of reconstructed pure spectra is found to be consistent with the standard spectrum of the target/known compound, and the pseudo-concentration of the reconstructed pure spectrum is meaningful, it can be concluded that the mixture contains the target compound, otherwise the target compound is absent. It can greatly reduce the separation requirements, greatly speeding up its applications particularly for quality control, testing and monitoring industries. Take the GC-MS as an example, FIG. 2 is a flow chart showing the analysis of mixture samples containing the target/known compound.

The method of the present invention utilises the EM algorithms in the analysis of the target/known compound to significantly reduce the separation requirements. It is very versatile for all different mixture samples as it is unnecessary to separate the target/known compound out from other components, nor are there any more requirements to develop a variety of analytical methods. Thus, the present invention is a fast and versatile method.

A. Detailed Explanation of BTEM, tBTEM and MREM Algorithms Used in the Present Invention:

When a sample is analyzed by GC-MS, a set of data, A_{k×υ}, was sampled and exported by a computer, wherein k is the number of sampling time, e.g. k=21 when a sample was sampled from 10-12 min with an interval of 0.1 sec; υ is the number of data channels (k<υ), e.g. υ=91 when sampled from m/z=10-100 with an interval 1 m/z in mass spectrometry.

The standard algorithms are listed in the time order as follows:

1. A singular value decomposition (SVD) is performed on A_{k×υ} according an equation (1). After truncating off physical meaningless parts of right singular matrix V^{T}_{υ×υ} and zero part of diagonal matrix S_{k×υ}, V^{T}_{k×υ} and S_{k×k} are obtained. Matrix U is not be used at all.

A_{k×υ}=U_{k×k}×S_{k×υ}×V_{υ×υ}^{T} (1)

2. Inspect every row vector in matrix V^{T}_{k×υ} to identify those row vectors that appear to represent only noise. For example, the row vectors after the row j all appear to represent noise, then we discard these (j+1)-k row vectors to obtain V^{T}_{J×υ}.

3. Identify those j row vectors remained in V^{T}_{j×υ}, and users may be interested in one or more interesting m/z peaks or a range, e.g. peak m/z=91 or range m/z=90-100. These peak(s) or range(s) will be used to do “targeting” and start to calculation.

4. First, a random vector T_{1×j} is generated by a computer. T is always updated by optimization method until the right spectrum is found. Then estimate the vector a^{est} in relation with a pure spectrum by equation (2), and a^{est} would change with the change of T till the end of optimization; the final a^{est} will be treated as a pure spectrum. The Matrix S (in step 1) in the equation (2) can be used or not as actually required.

a^{est}_{l×υ}=T_{l×j}×(S_{j×j}×V_{j×υ}^{T}) (2)

5. Normalize the estimated spectrum a^{est} by targeting the peak(s) or maximum peak(s) within the range(s) according to the equation (3). Let the normalized spectrum be denoted as a. This step is called as “targeting”, wherein a′ and a″ are the targeted peak and range.

$${\hat{a}}_{1 \times v} = \frac{{a}_{1 \times v}^{est}}{max ( {a}^{′} ) + max ( {a}^{″} )} \qquad ( 3 )$$

6. Construct objective and penalty functions by the obtained aₕₐₜ. The equation (4) represents general objective and penalty functions. Specific objective and penalty functions have different expressions according to different types of spectroscopy. Please refer to relevant references (references \textcircled{1}, \textcircled{2} and \textcircled{3}) for details. Where P is the penalty function. The estimated pseudo concentrations are obtained by the equation (5).

$$\begin{matrix}min ( G ) = {\sum }_{v} {\hat{a}}_{1 \times v} + P ( {\hat{a}}_{1 \times v} , {\hat{c}}_{k \times 1} ) & ( 4 ) \\ {\hat{c}}_{k \times 1} = {A}_{k \times v} \times {\hat{a}}_{v \times 1}^{T} \times {( {\hat{a}}_{v \times 1} \times {\hat{a}}_{v \times 1}^{T} )}^{- 1} & ( 5 )\end{matrix}$$

7. Check the objective function value against a stopping criterion. If the stopping criterion is met, then output a pure spectrum a^{est} and a pseudo-concentration C_{k×1}. If the stopping criterion is not met, generate another T_{1×j} by optimization method. Then repeat steps 4 to 7 until the end of optimization.

Repeat steps 3 to 7 so as to target different peaks or ranges, obtain different spectra and pseudo-concentration by means of algorithms. Then the other pure spectra within the mixture or even all pure spectra will be obtained.

### REFERENCES

\textcircled{1}. Chew, W., E. Widjaja, and M. Garland, Band-target entropy minimization (BTEM): An advanced method for recovering unknown pure component spectra. application to the FTIR spectra of unstable organometallic mixtures. Organometallics, 2002. 21(9): p. 1982-1990.
\textcircled{2}. Zhang, H. J., et al., Weighted two-Band Target Entropy Minimization for the reconstruction of pure component mass spectra: Simulation studies and the application to real systems. Journal of the American Society for Mass Spectrometry, 2003. 14(11): p. 1295-1305.
\textcircled{3}. Zhang, H., W. Chew, and M. Garland, The multi-reconstruction entropy minimization method: Unsupervised spectral reconstruction of pure components from mixture spectra, without the use of a Priori information. Applied Spectroscopy, 2007. 61(12): p. 1366-1372.

B. The Utilisation of the Optimization Method:

Optimization methods need to be used in the EM algorithms (BTEM, tBTEM and MREM) (to get T).

First, the EM method will input the V^{T} data obtained after SVD into the optimization objective equation (4) to build an n-dimensional vector space; then a optimization method is used to search for the pure spectrum in this vector space. For different targeted peaks or ranges, different vector space is constructed.

As shown in FIG. 19, BTEM/tBTEM in a search mode uses a global optimization method and regards the global minimum to correspond to a pure spectrum. Thus, only a single pure spectrum can be obtained after each optimization. Later, Zhang Huajun found (the above reference \textcircled{3}) that each local minimum in the n-dimension vector space corresponds to a pure spectrum, therefore MREM algorithm was developed. MREM uses a local optimization method to find a pure spectrum at each local minimum during each optimization step. Hence, many pure spectra can be obtained from just one optimization step, which greatly accelerates the speed of the method and enhances its capability. By combining BTEM, tBTEM, MREM methods together, a better effect arises. The method is able to find a pure spectrum which has been 100% submerged by other spectra, and can be used in difficult systems such as the ultraviolet spectrum.

### Example 1

### Using the Method Present Invention to Analyze Jet Fuel by a GC-MS

1.1: Experimental Conditions

A jet fuel sample (commercially available) is analysed using the Agilent GC-MS with a HP5-MS column, with temperature starting from 30° C. and holding for 5 minutes and then increasing from 30° C. to 300° C. with a ramp speed of 10° C./min. Jet fuel is a complex mixture, mainly made up of a lot of structurally similar alkanes and aromatic components including many isomers. As the degree of mixing is very complicated, the individual components of the jet fuel mixture cannot be completely separated by using GC-MS.

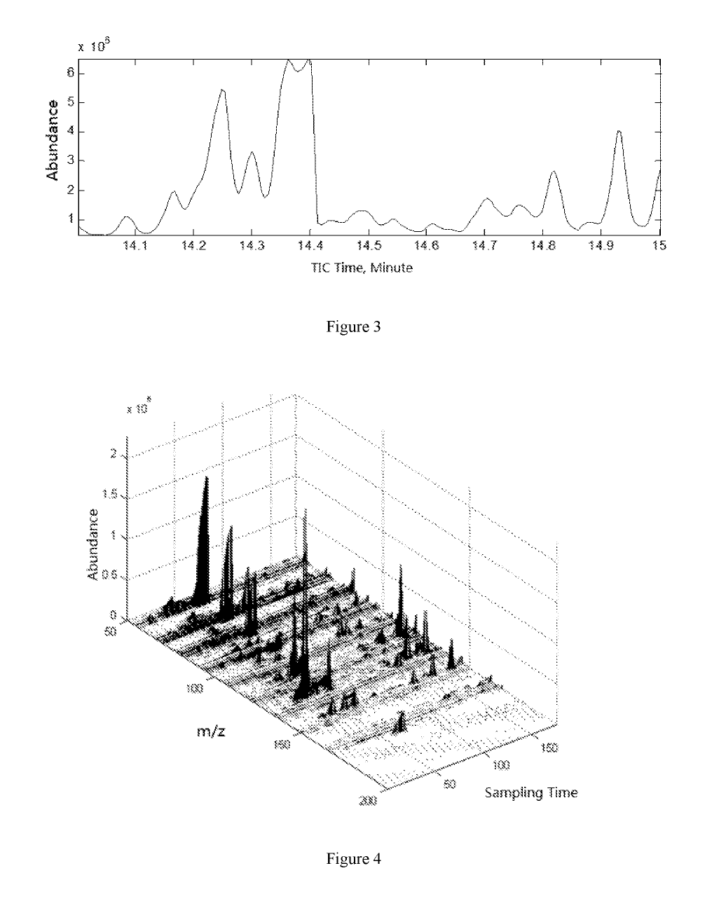

The mixture after being subjected to the above instrumental analysis will give a TIC (Total Ion Current) spectrum, with the peaks from the interval of 14 to 15 minutes of the TIC spectrum as shown in FIG. 3. A data set with a total of 176 mixture spectra was obtained by exporting data from the spectra in this time period, and this data set is plotted in FIG. 4 (shown as a 3-D mass spectra). The mass spectrum data point ranges from 50-200 m/z with interval of 1 m/z (each sampling time refers to a specific TIC time, and the exported mass spectrum data point ranges from 50-200 m/z with interval of 1 m/z).

1.2: The Rapid Discovery of Known Component in the Jet Fuel Mixture

Jet fuel samples contain a lot of alkanes. From the Japan AIST (National Institute of Advanced Industrial Science and Technology, Japan) organic compound database, an n-undecane

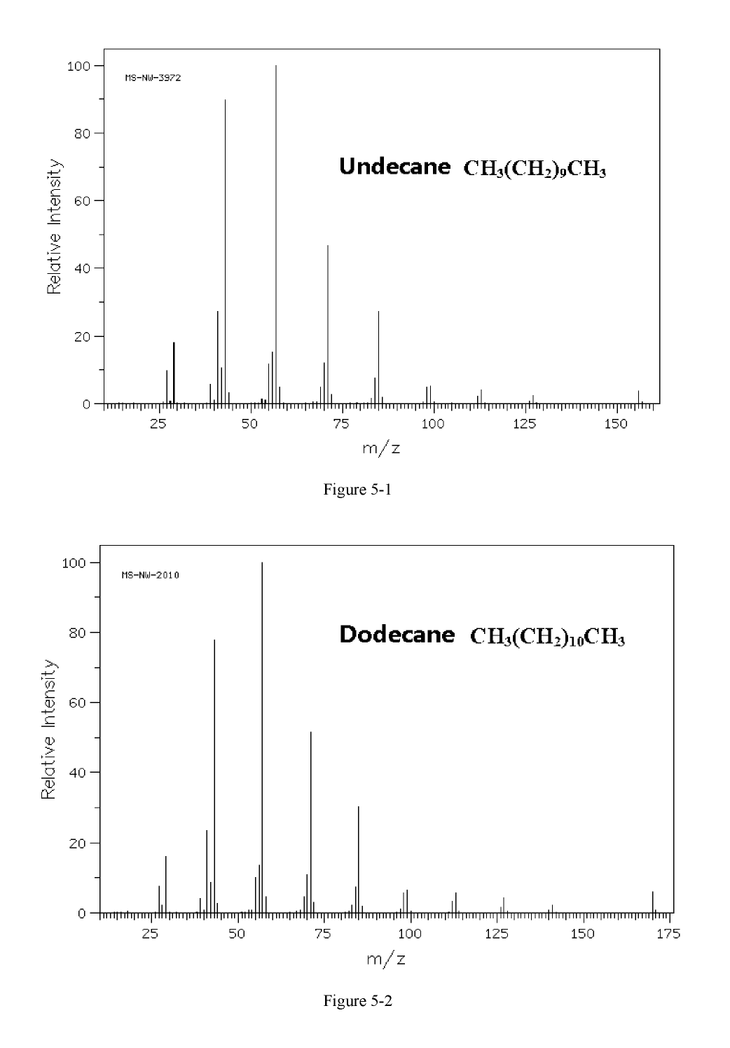

EI-MS standard spectra is found (see FIG. 5-1). The highest peak of n-undecane is at m/z=57 with the molecular peak at 156 m/z. For another alkane, the highest peak of n-dodecane also has a peak at m/z=57 with a molecular peak at 170 m/z.

The exported data from the mixture is subjected to the EM algorithm to identify if there is n-undecane within the TIC=14-15 min interval. EM algorithm is used to separately target peak m/z=57 (specifically using BTEM algorithm), or target both the peaks m/z=57 and 156 together (specifically using tBTEM algorithm) with each targeting methods being repeated five times. Calculation using both algorithms showed that no consistent spectra can be found when the reconstructed pure spectra were compared with the standard spectra for n-undecane, which suggests the absence of n-undecane in the TIC=14 to 15 minutes interval. This result is consistent with the actual experimental results, as the calibration with pure n-undecane showed that under the same experimental conditions the peak time of the n-undecane is around 12.75 minutes.

The above EM algorithms are repeated to identify if n-dodecane is present within the TIC=14-15 min interval. By separately targeting peak m/z=57 or targeting both the peaks m/z=57 and 156 together for five times, the reconstructed pure spectra were found to match the n-dodecane standard spectra (FIG. 5-2).

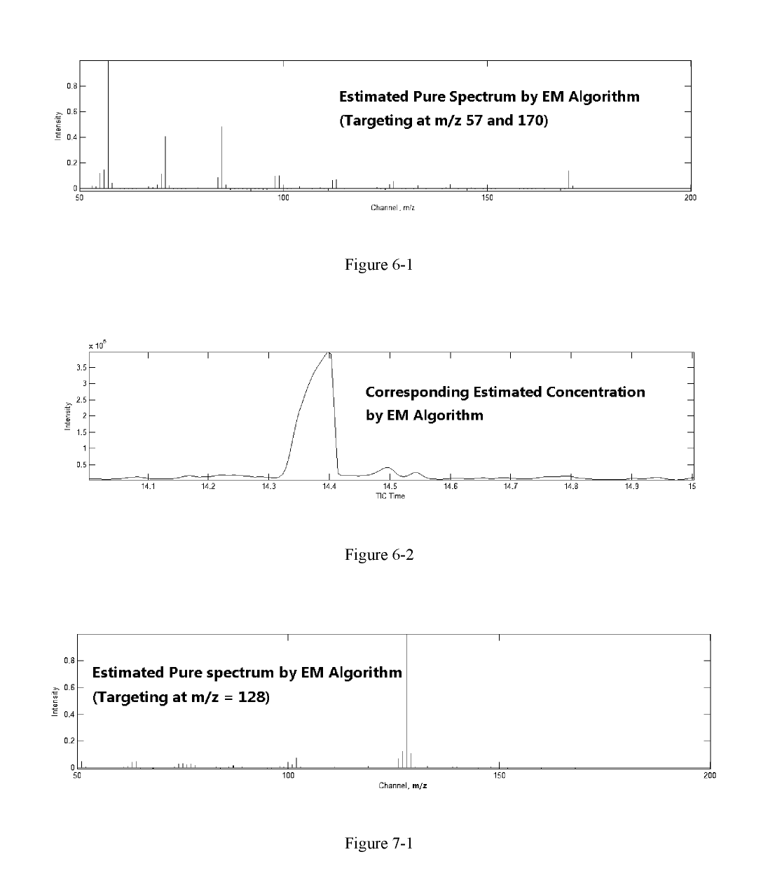

The pure spectrum obtained by targeting the peaks m/z=57 and 170 is displayed as shown in FIG. 6-1 with the corresponding calculated pseudo-concentration peaks of n-dodecane showing a peak time at about 14.37 minutes as shown in FIG. 6-2. From the above results as shown in FIG. 3, it can be seen that in the TIC=14.33-14.43 minutes interval there is obviously an overlapping peak of a mixture. The overlapping peak comprises at least two components, the pure spectrum of which cannot be identified as the overlap of the peaks are too severe. The present invention using EM calculation has successfully reconstructed an n-dodecane pure spectrum with a corresponding pseudo-concentration of n-dodecane whose peak time (14.37 minutes) matches the calibration using pure n-dodecane which showed a peak time of around 14.38 minutes when carried out under the same experimental conditions.

This embodiment easily allows the identification and analysis on whether a mixture sample contains a known component or target compound. By using the standard spectra of known compound/target compound, we can use the method described above on mixture spectra of a poorly separated sample to quickly identify if the sample contain the known compound/target compound. If the known compound/target compound is present, the concentrations thereof (calibration using the standard concentration curve) and peak time can be easily calculated.

Thus, the present invention can be used for applications requiring quick analysis, and is very useful for quality control and quality supervision. In particular, the efficiency of the present invention is very high as different samples can be analyzed by similar methods, and the sample need not be separated and need no complex pre-treatments.

1.3: The Rapid Identification of Unknown Component of a Mixture

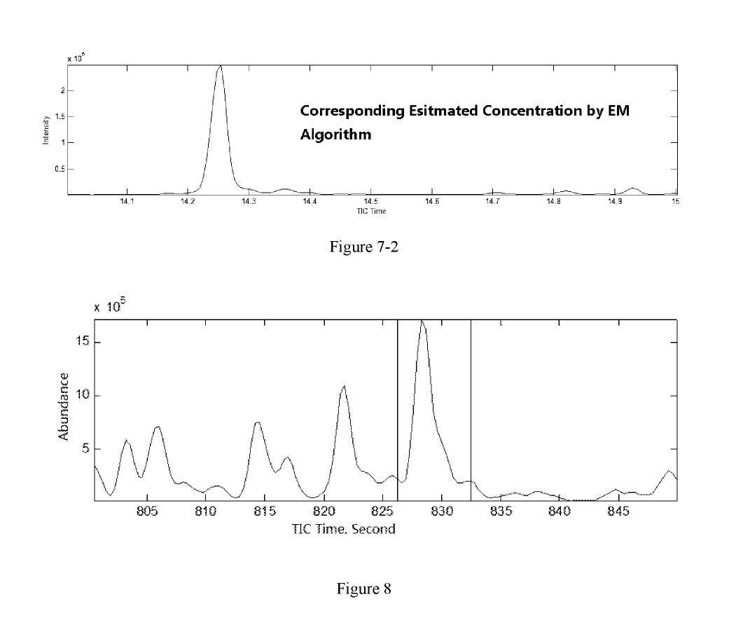

After viewing the experimentally obtained TIC peak (FIG. 3), a peak is found around TIC=14.25 min. As this peak overlaps with other neighbouring peaks, the peaks of the pure components cannot be identified. At the TIC=14.25 min, a peak m/z=128 was observed in the mixed mass spectra (the sampling method is the same as above). The EM algorithm is used to target the peak m/z=128, and a reconstructed pure spectrum and its pseudo-concentrations are obtained as shown in FIGS. 7-1 and 7-2.

However, if we do not compare the reconstructed pure spectrum with the pure component standard spectra in the database, we cannot identify what the reconstructed pure spectrum represents. Through comparing the reconstructed pure spectrum with the spectra from NIST standard spectra database, we determine that the reconstructed pure spectrum is consistent with the aromatic compound naphthalene standard mass spectra, which suggests that the peak in TIC=14.25 min is the peak of the compound naphthalene. Under the same conditions, naphthalene is used to do calibration, the naphthalene TIC peak time and the present embodiment's pseudo concentration peak time are found to coincide.

In this embodiment, the experiment which quickly identifies the unknown composition of a mixture demonstrates that identification of unknown component in the mixture sample can be quickly accomplished, without the need of good chromatographic separation of the sample or prior information about the component, by only using the information from the mixture spectra (such as peaks of mass spectrum), and further the information on the structure of each component can be obtained through comparison with the standard spectra database.

### Example 2

### Using the Method of the Present Invention to Analyze a Volatile Sample by a GC-MS

2.1: Experimental Conditions:

An algae oil which undergoes catalytic hydrogenation to obtain a jet fuel sample (obtained by conventional experimental methods) is analysed on the Agilent GC-MS with a HP5-MS column, with temperature starting from 30° C. and holding for 5 minutes and then increasing from 30° C. to 300° C. with a ramp speed of 10° C./min.

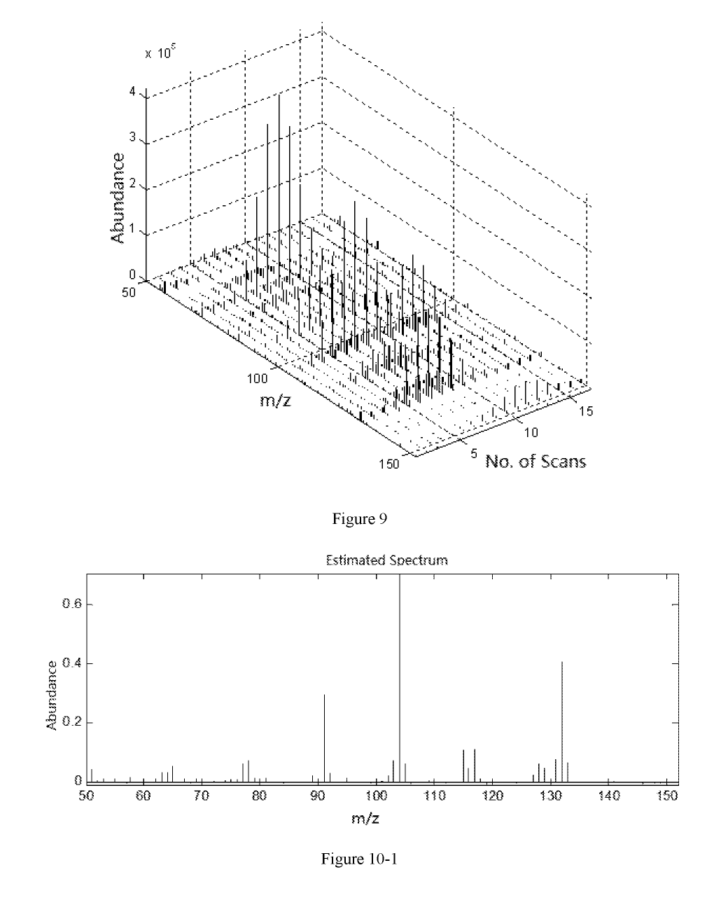

The mixture was subjected to the above instrumental analysis to give a TIC (Total Ion Current) spectrum. The peak from the TIC interval of 800 to 850 seconds is shown in FIG. 8. FIG. 8 shows an asymmetric peak in the interval of 827-832 seconds which suggests that it might not be a pure component peak. Data were exported from the spectra in the interval of 827-832 seconds for 17 times and plotted a series of mixture spectra as shown in FIG. 9 (shown as a 3-D mass spectra). The mass spectrum data point ranges from 50-150 m/z with interval of 0.5 m/z.

2.2: EM Algorithms: Discovery and Characterization of Unknown Component

2.2.1: Target Peak m/z=91:

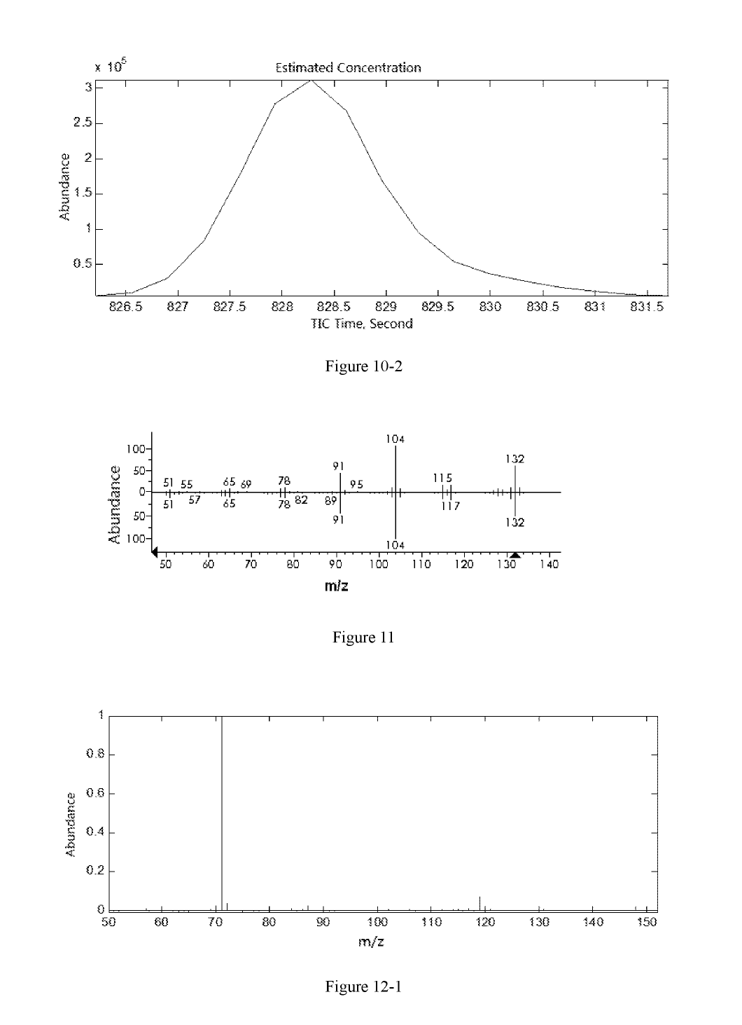

The EM algorithm (specifically BTEM algorithm) is used to target the peak m/z=91 so as to obtain, after calculation, the reconstructed pure spectra and its corresponding pseudo-concentrations as shown in FIG. 10-1 and FIG. 10-2. A relatively symmetrical pseudo-concentration of the reconstructed pure spectra is observed.

The data of the reconstructed pure spectrum after being exported to *.msp format with MREM software are imported into the Agilent GC-MS instrument and compared with the standard spectra in the NIST database. The two spectra used for comparison are displayed as shown in FIG. 11. The results showed the reconstructed spectrum matches the compound C₁₀H₁₂, with a structural formula of:

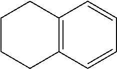

2.2.2: Target Peak m/z=71:

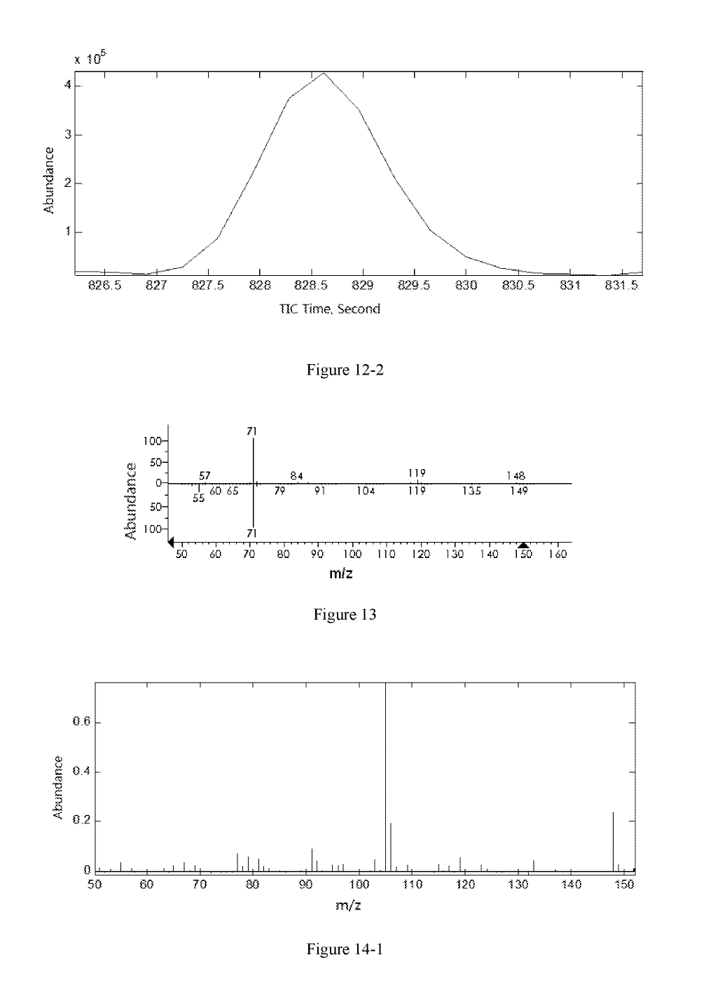

The EM algorithm (specifically BTEM algorithm) is used to target the peak m/z=71 so as to obtain, after calculation, the reconstructed pure spectra and its corresponding pseudo-concentration as shown in FIG. 12-1 and FIG. 12-2. A good symmetrical pseudo-concentration of the reconstructed pure spectra is observed.

The data of the reconstructed pure spectrum after being exported to *.msp format with MREM software, are imported into the Agilent GC-MS instrument and compared with the standard spectra in the NIST database. The two spectra used for comparison are displayed as shown in FIG. 13. The results showed the reconstructed spectrum matches the compound C₅H₁₁Br, with a structural formula of:

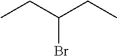

2.2.3: Target Peak m/z=105:

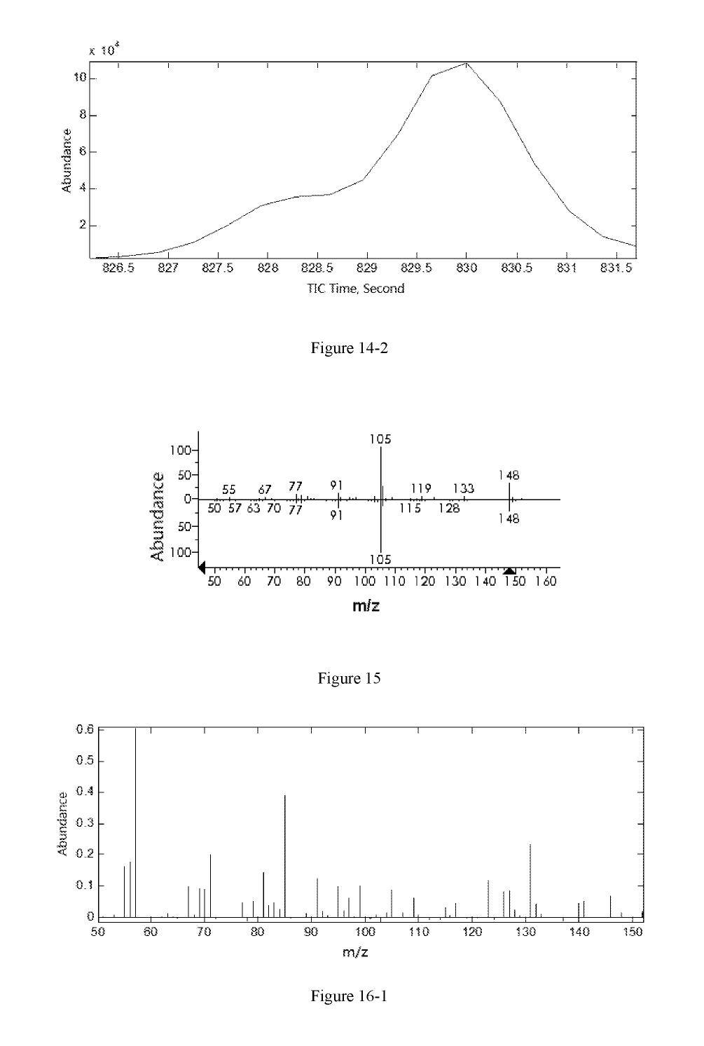

The EM algorithm (specifically BTEM algorithm) is used to target the peak m/z=105 so as to obtain, after calculation, the reconstructed pure spectra and its corresponding pseudo-concentration as shown in FIG. 14-1 and FIG. 14-2. The pseudo-concentration of the reconstructed pure spectra is strange (not very symmetrical) but is still a possible reconstruction.

The data of the reconstructed pure spectrum after being exported to * .msp format with MREM software, are imported into the Agilent GC-MS instrument and compared with the standard spectra in the NIST database. The two spectra used for comparison are displayed as shown in FIG. 15. The results showed the reconstructed spectrum matches the compound C₁₁H₁₆, with a structural formula of:

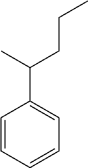

2.2.4: Target Peak m/z=57 and 85:

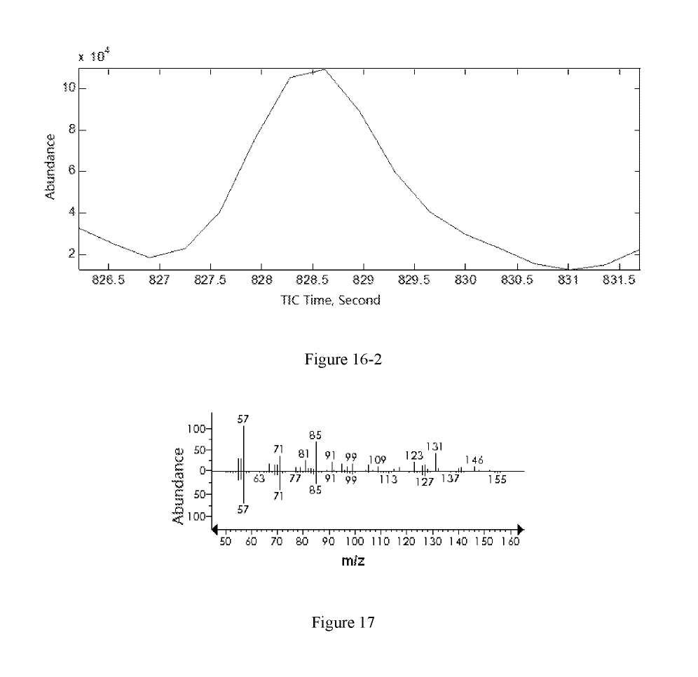

The EM algorithm (specifically tBTEM algorithm) is used to target the peak m/z=57 and 85 so as to obtain, after calculation, the reconstructed pure spectra and its corresponding pseudo-concentration as shown in FIG. 16-1 and FIG. 16-2.

The data of the reconstructed pure spectrum after being exported to * .msp format with MREM software, are imported into the Agilent GC-MS instrument and compared with the standard spectra in the NIST database. The two spectra used for comparison are displayed as shown in FIG. 17. The results showed the reconstructed spectrum matches the compound C₁₁H₂₆, with a structural formula of:

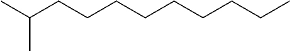

2.3: Quantitative Analysis:

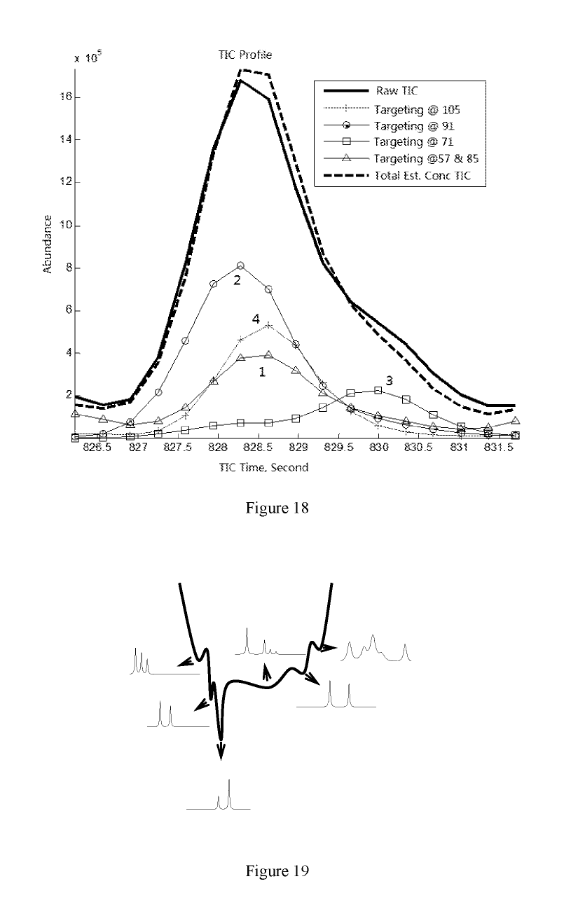

The pseudo-concentrations of the four reconstructed pure spectra are corrected and their reconstructed TIC concentrations are compared with the experimental real TIC concentration (as shown in FIG. 18). The results show that the peak shape of the reconstructed total TIC concentrations and that of the actual TIC concentrations are consistent. The values of their area are shown in the following table:

Relationship between TIC Concentration Areas of
reconstructed spectra with original spectra

| | |
|---|---|
| Area of Real Spectra TIC Concentration: | 10835841 |
| Area of Reconstructed Pure Spectra's | 10668662 |
| Total TIC Concentration: | |
| Total Reconstructed Area/Real Area = | 98.5% |

Data of Various Reconstructed Pure Spectra's TIC Concentration Area

| | | Percentage of |
|---|---|---|
| | | Total Reconstructed |
| No. | TIC Concentration Area | Concentration |
| Curve 1 | 2484060 | 23.3% |
| Curve 2 | 4142366 | 38.8% |
| Curve 3 | 1388395 | 13% |
| Curve 4 | 2653840 | 24.9% |

In FIG. 18, each of the curves means: a thick solid line represents the actual (or original) TIC concentration; a thick dotted line represents the simple summation of the four reconstructed concentrations used for comparison with the actual TIC concentration; line 1 represents a corrected TIC concentration of a reconstructed pure spectrum with targeting of the peak m/z=57 and 85; line 2 represents a corrected concentration of a reconstructed pure spectrum with targeting of the peak m/z=91; line 3 represents a corrected concentration of a reconstructed pure spectrum with targeting of the peak m/z=71; line 4 represents a corrected concentration of a reconstructed pure spectrum with targeting of the peak m/z=105.

2.4: Discussions:

Use of chemical analysis to find the unknown composition of a mixture has always been a very difficult and complicated endeavour. This embodiment illustrates that the unknown composition can be easily found to obtain its reconstructed pure spectrum by using only the mass spectrum peaks of a mixture spectra (such as m/z=105) and the EM algorithms. After comparison with the pure spectra found in the standard spectra database, it can be known what substances the pure spectra of those unknown compositions represent. This embodiment also shows that the EM algorithm can well reconstruct the TIC concentration of each component, and therefore obtain quantitatively the concentration of each component by using the typical GC-MS method.

### Example 3

### Application MREM Algorithm on the GC-MS for the Analysis of Volatile Substances, by the Methods of the Present Invention

The MREM algorithm is applied with the same data from Example 2, and the same results as in Example 2 are obtained.

MREM Application Parameters:

Targeted peak range: the entire range, m/z=50-150 (it does not need to specify a particular peak and let MREM algorithm to find it out on its own).

Number of peaks to target: Target only one peak each time.

Optimization method: a simulated annealing method to perform local optimization (see the above reference \textcircled{3}).

Times of Optimization: 30 times.

After MREM algorithm is applied with the data from example 2 and the above parameters, 30 reconstructed pure spectra can be obtained. After removing any duplicate reconstructed pure spectra, the same results as in example 2 can be obtained, specifically the same four pure spectra, with the results of TIC the same as those in FIG. 18.

### Example 4

### Applications of MREM and tBTEM Algorithms in Combination to the Analysis of Volatiles by GC-MS, by the Methods of the Present Invention

The same data from Example 2 were subjected to calculations by the MREM and tBTEM algorithms in combination. It took advantages of the MREM algorithm by its range-targeting and its local optimization functions. It also took advantages of the tBTEM algorithm by its multi-range targeting function. By using both algorithms together, the results obtained are the same as those found in Example 2.

MREM application parameters:

Targeted peak range: two ranges of m/z=50-100, and m/z=101-150 (the use of the function of tBTEM to target multiple peaks and the use of the function of MREM to target a range (without the need to specify a particular peak)).

The number of targeted peaks: one for each range, a total of two peaks (this is the characteristics of tBTEM).

Optimization method: Use of a simulated annealing method to perform local optimization (the above reference \textcircled{3}).

Times of Optimization: 30 times.

After the MREM and tBTEM algorithms are used in combination with the data from example 2 and the above parameters, 30 reconstructed pure spectra (including pure spectra and combined spectra) can be obtained. After removing any duplicate reconstructed pure spectra and the combined spectra (reference can be made to the above reference \textcircled{2} for the detailed calculation), the same results as in example 2 can be obtained, specifically the same four pure spectra, with the TIC results the same as those shown in FIG. 18.

While the present invention has been described in detail with reference to general and specific embodiments, various modifications or improvements will be apparent to and can be readily made by those skilled in the art. Hence, all these modifications or improvements made within the spirit and scope of the present invention are to be regarded as being protected under the scope of the invention as claimed.

1. A method for analyzing mixture components, comprising the steps of:
(1) separating mixture samples with constant concentration ratios using chromatographic techniques to obtain preliminary chromatograms;
(2) within any range of the preliminary chromatograms as obtained from step (1), carrying out a sampling as required, so as to obtain a series of spectra at different retention time, which is called the mixture spectra (i.e., a mixed spectra);
(3) using serial methods of the EM algorithms on the mixture spectra obtained from step (2) to calculate various reconstructed pure spectra and the corresponding pseudo concentrations;
wherein the pseudo concentration is the concentration that corresponds to the reconstructed pure spectra, which is calculated out when using EM algorithms to reconstruct the pure spectra;
for the analysis of a mixture sample containing unknown substances, one need to obtain as much information as possible on the components from the mixture spectra obtained in step (2) after multiple repeated calculation by using the serial methods of the EM algorithms under different parameters so as to get as many reconstructed pure spectra as possible; and
the different parameters refer to targeting different peaks, using different objective functions and penalty functions or using different optimization methods.

2. The method for analyzing mixture components according to claim 1, characterized in that the preliminary chromatogram obtained from step (1) include peaks of pure component and the overlapping peaks of the mixture.

3. The method for analyzing mixture components according to claim 3, characterized in that for the overlapping peaks of the mixture, step (2) and step (3) are utilised for analysis.

4. The method for analyzing mixture components according to claim 1, characterized in that any range of the preliminary chromatograms obtained in step (1) refers to a part of the preliminary chromatogram, or the whole preliminary chromatogram.

5. The method for analyzing mixture components according to claim 1, characterized in that in step (1), the chromatographic techniques are: gas chromatography (GC), liquid chromatography, or a combination of both.

6. The method for analyzing mixture components according to claim 1, characterized in that in step (1), mixture spectra can be obtained by a detector after using chromatographic techniques to carry out separation.

7. The method for analyzing mixture components according to claim 6, characterized in that the detector can be selected from the group comprising one or a combination of MS, IR, UV, fluorescence, spectrophotometer and NMR detectors.

8. The method for analyzing mixture components according to claim 1, characterized in that in step (3), the serial methods of EM algorithms comprise one or a combination of BTEM, tBTEM or MREM methods.

9. The method for analyzing mixture components according to claim 8, characterized in that for each operation of the BTEM or tBTEM method, one reconstructed pure spectrum can be obtained; for each operation of the MREM method, multiple reconstructed pure spectra can be obtained.

10. (canceled)

11. The method for analyzing mixture components according to claim 1, characterized in that in step (3), for analyzing if a mixture sample has a target compound/known compound, the target compound/known compound standard spectrum can be used as a reference for calculation using the serial methods of EM algorithms, reconstruction methods using different parameters can be used to obtain the target compound/known compound's reconstructed pure spectrum; during multiple reconstruction, if the reconstructed pure spectrum and the standard spectrum of the target compound/known compound are compared and found to be consistent, and the pseudo-concentration of the reconstructed pure spectrum is meaningful, the mixture contains the target compound/known compound; otherwise, the target compound/known compound is absent.

12. The method for analyzing mixture components according to claim 1, characterized in that after finishing the step (3), the reconstructed pure spectra can be compared with the spectra found in a standard database to confirm their information; if the reconstructed pure spectrum is consistent with some spectrum in the standard database, the reconstructed pure spectrum can be confirmed to be the component as represented in the spectrum of the standard database.
